(19) United States
(12) Patent Application Publication
(10) Pub. No.: US 2003/0223552 A1
(43) Pub. Date: Dec. 4, 2003

(54) Means and method for computerized call logging

(76) Inventor: Gustav Schoeman, Johannesburg (ZA)

Correspondence Address: John W. Olivo. Jr., Ward & Olivo, Suite 300, 382 Springfield Avenue, Summit, NJ, 07901, US

(21) Appl. No.: 10/309,768

(22) Filed: Dec. 4, 2002

Related U.S. Application Data
(60) Provisional application No. 60/338,775, filed on Dec. 5, 2001.

(51) Int. Cl. H04M 1/64; H04M 11/00

(52) U.S. Cl. 379/88.13; 379/88.14; 379/85

(57) ABSTRACT

A computerized call logger using a computer having a sound conversion card, which may be a voice modem or a Sound Blaster® compatible card, is used as an input device and for saving voice recordings in digital form. The voice recordings are retained on computer storage media, such as a hard drive, where the recordings may be automatically assigned filenames, which are maintained in a database associated with one or more logging computers, such that a number of computers may be used for logging while a single database may be used to retain information about all logged calls. Further, the present invention includes means and apparatus for sending individual calls to recipients via electronic mail and exchanging voice messages over a network, such as the Internet.

### CROSS REFERENCE TO RELATED APPLICATIONS

This application relates to, claims the benefit of the filing date of, and incorporates by reference U.S. Provisional Application No. 60/338,775 entitled “Computerized Call Logger”, having inventor Gustav Schoeman, and filed on Dec. 5, 2001.

### FIELD OF THE INVENTION

The present invention relates to a hardware and software system for logging telephone calls. In particular, the present invention relates to a hardware and software system for logging, storing, and cataloging telephone calls, which are recorded while they are being conducted, and/or voice messages, which may be recorded for delivery via electronic mail (hereinafter referred to as “e-mail”).

### BACKGROUND OF THE INVENTION

Heretofore, businesses have used various types of recording devices and recording systems for logging telephone calls. In particular, businesses have used various types of tape recorders and other devices for logging telephone calls, which may be associated with customer service or other functions conducted by the business. Problems with the devices and systems of the prior art relate to the manner in which calls are recorded as well as the users' ability to locate and to make use of particular calls in conducting their business. Other problems, which have heretofore existed, relate to locating and retrieving specific portions of logged calls, as well as using the calls (or portions of the calls) in the conduct of the business. For example, telephone calls recorded on tape-recording devices must be reviewed in real time. Alternatively, the user must fast forward to a location on a tape recording in an effort to locate a specific portion of a conversation, which may be relevant. Then, once a call has been identified and a relevant portion marked, transfer of that portion of the call to another user in the business requires the call to be recorded again or otherwise transferred to a different user within the business.

Digital recording devices provide random access to specific locations of a particular recording. Accordingly, digital devices and computer software have been designed for recording telephone conversations and storing said telephone conversations on computer hard drives. Problems with the digital systems of the prior art involve difficulty in locating specific conversations, as the systems of the prior art generally require that each conversation be given a unique name, selected by the user, so that multiple calls can be stored on a computer hard drive. Also, the digital call logging systems of the prior art do not provide an easy means for entering specific recorded telephone conversations in a database.

Other problems with the digital telephone logging systems of the prior art involve the inability to readily connect to telephone systems in use in specific offices. Accordingly, the hardware used to interface certain systems of the prior art fails to provide an easy way to interface the systems with cordless telephones or speakerphones.

Yet another problem with the systems of the prior art is that each system is necessarily associated with a particular computer. Consequently, if a business has more than one telephone in use at a particular time, each user collects separate telephone calls, which are then kept on separate computers, and there is no easy way to locate a specific call in which a particular user participated.

The following references, which are discussed below, were found to relate to the field of call logging systems: Dawson U.S. Pat. No. 6,252,588 (hereinafter referred to as “Dawson”); Rosen et al. U.S. Pat. No. 5,784,436 (hereinafter referred to as “Rosen”); Bentley et al. U.S. Pat. No. 5,727,047 (hereinafter referred to as “Bentley”); and Hyde-Thomson U.S. Pat. No. 5,717,742 (hereinafter referred to as “Hyde-Thomson”).

Dawson discloses a system and method for sending and receiving audiovisual e-mail. In particular, Dawson discloses a software interface that facilitates selecting recipient e-mail addresses, creating audiovisual messages, and recording audio to be included in e-mail. Additionally, Dawson discloses a method for sending the audiovisual e-mail via a telephone connection. However, Dawson fails to disclose a method for recording audio received by a telephone. Dawson also fails to disclose a method for automatically logging the recorded audio. Finally, Dawson's method fails to disclose a method that does not require each user to purchase and install a proprietary e-mail program. The present invention overcomes these drawbacks.

Rosen discloses a system for recording audio received by a telephone on a digital medium within a computer. Specifically, Rosen discloses a system in which a sound card contained within a computer is connected to a telephone line. The Rosen system automatically begins recording whenever a voltage pulse, which indicates an on-hook to off-hook transition, occurs on the telephone line. However, Rosen fails to disclose a method for effectively storing the recorded audio. Rosen also fails to disclose a method for logging voice recordings received from an input other than a telephone, such as a microphone. Also, Rosen discloses only one method of connecting the telephone to the computer (i.e., via the telephone line). Finally, Rosen does not disclose a method for automatically generating an e-mail message containing the recorded audio file. The present invention does not have these limitations.

Bentley discloses a method for interfacing a personal computer to a telephonic device that is capable of storing data when the computer is off and transmitting the stored data to the personal computer when the computer is on. The telephonic device is connected to an analog telephone line and is capable of storing voice data, caller identification information, facsimile messages, and electronic mail messages. Bentley fails to disclose a system that does not require a proprietary telephonic device or proprietary software. Furthermore, Bentley fails to disclose a system that is compatible with digital telephones, Integrated Services Digital Network (hereinafter referred to as “ISDN”) lines, Voice over Internet Protocol, or broadband lines. The present invention overcomes these limitations.

Hyde-Thomson discloses a method and system for integrating a voice-mail system and an e-mail system. The system assigns a voice mailbox number to each e-mail address. Additionally, the Hyde-Thomson system utilizes a voice gateway computer to receive a voice message via telephone and convert the voice message to a digital audio file. If a caller leaves a voice message for a voice mailbox number that is associated with an e-mail address, the digital audio file associated with the voice message is sent via a network to the e-mail address. Hyde-Thomson fails to disclose a method of sending a voice message to an e-mail user who does not subscribe to the Hyde-Thomson system. Also, Hyde-Thomson fails to disclose a system that can operate without the expense of a voice gateway computer. The present invention does not have these limitations.

The prior art is completely devoid of a simple system that allows a user to easily and inexpensively record, store, and retrieve voice messages or telephone calls utilizing standard personal computer equipment and e-mail software. In light of the prior art, there is a clear need for an inexpensive system that can log voice recordings made through standard personal computer equipment and attach the resulting digital audio files for transmission via e-mail to any e-mail user regardless of the e-mail service to which the user subscribes.

### SUMMARY OF THE INVENTION

In accordance with the present invention, a telephone logging system and method has been developed which includes multiple embodiments of a hardware interface, which connects a computer system to a telephone system. The hardware interface may be selected so that the present invention will work with cordless telephones, speakerphones, or digital private branch exchange (hereinafter referred to as “PBX”) systems.

In addition, the present invention includes software, which automatically assigns names to the digital sound files, so that calls are automatically logged in a standardized manner. Another part of the system includes a database, which is used to store information about a call, including the name assigned to the computer file, its participants, and its subject. A particular feature of the database is that a single database may be used over a local area network (“LAN”) or wide area network (“WAN”) to allow call information relating to calls involving multiple users to be accessed from a single database.

Another feature of the present invention is the ability to allow users to identify specific calls, as well as to mark particular portions of calls for later access.

In addition, the present invention may send recordings or voice messages by e-mail to others.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

FIG. 1 is a schematic representation of the hardware of the preferred embodiment of the present invention including a computer, monitor, keyboard, mouse, telephone, and a hardware interface unit, which interfaces the computer to the telephone.

FIG. 2 is a plan view of the back of the computer shown in FIG. 1 in accordance with the preferred embodiment of the present invention in which a sound card interfaces audio signals to the computer;

FIG. 3 is a plan view of the back of the computer shown in FIG. 1 in accordance with an alternate embodiment of the present invention in which a voice modem or other telephony device interfaces audio signals to the computer;

FIG. 4 is a schematic representation of the hardware interface according to the preferred embodiment of the present invention illustrating the manner in which the hardware interface is connected between a telephone handset, a telephone base, and a computer;

FIG. 5 is a schematic representation of the hardware interface according to an alternative embodiment of the present invention illustrating the manner in which the hardware interface is connected between a telephone line, a telephone base, and a computer;

FIG. 6 is a schematic representation of a plurality of computers, each equipped with the hardware and software of the present invention, illustrating the manner in which a plurality of computers may be networked together to share a single database;

FIG. 7 is a flowchart illustrating the operation of the software of the present invention;

FIG. 8 is a circuit diagram of the preferred embodiment of the telephone base-to-handset hardware interface of FIG. 4;

FIG. 9 is a circuit diagram of an embodiment of the telephone line-to-telephone base hardware interface of FIG. 5; and

FIG. 10 is a circuit diagram of an alternate embodiment of the telephone base-to-handset hardware interface of FIG. 4.

### DETAILED DESCRIPTION OF THE PREFERRED EMBODIMENT

As required, a detailed illustrative embodiment of the present invention is disclosed herein. However, techniques, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred embodiment (as well as some alternative embodiments) of the present invention.

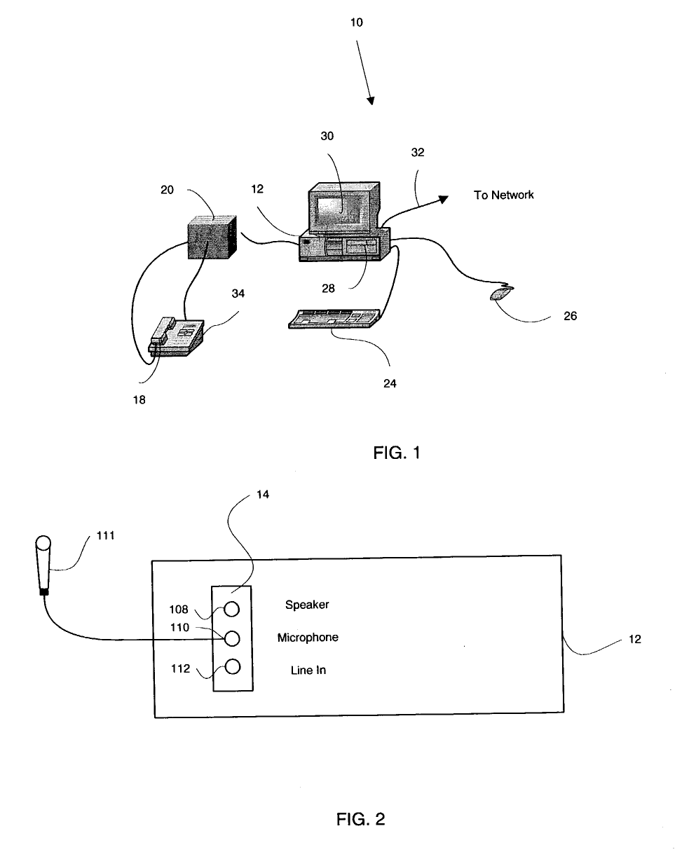

Referring first to FIG. 1, in accordance with the present invention, a telephone call logging system 10, which may be used to both record calls (or other voice messages) and to enter them into a database, has been developed. In addition, the design of the call logging system 10 of the present invention allows several such systems to be interfaced to separate telephones in such a way that calls logged at any one of the telephones may be retained in a central database. In one embodiment, the present invention may be used with speakerphones or cordless telephones, whereas in another embodiment, the present invention may be used with digital PBX, ISDN lines, or broadband lines.

As will be understood by those skilled in the telephone art, when one connects a device, such as the call logging system 10 of the present invention, to the telephone line, it is necessary for the device to comply with the requirements of Federal Communications Commission (hereinafter referred to as “FCC”) Part 68. Thus, if a device is connected between a telephone and a telephone jack in the wall, that device must be FCC Part 68 compliant. On the other hand, if a device is connected between the telephone handset and the telephone base, FCC Part 68 compliance is not necessary. In accordance with the present invention, different interfaces may be used and by selecting an appropriate interface, different benefits may be achieved.

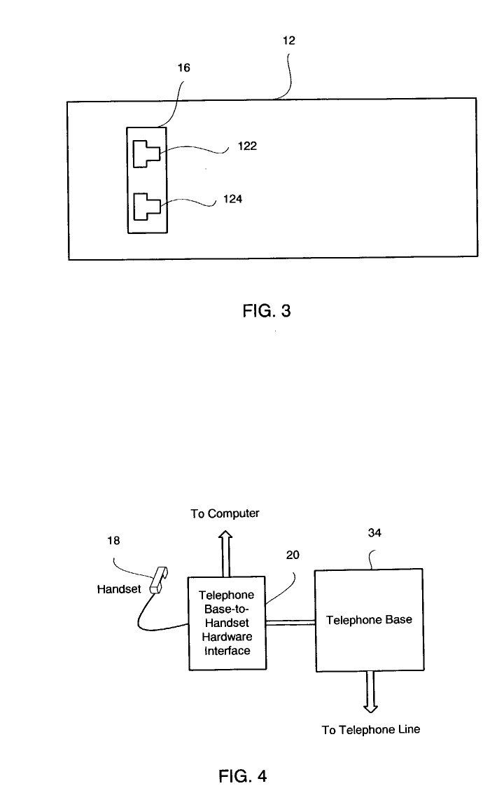

As shown in FIG. 1, the call logging system 10 of the present invention is comprised of a computer 12, such as an IBM-compatible personal computer. The computer 12 includes an audio device therein, which is capable of receiving analog audio signals and converting them to digital format for storage. As will be understood by those skilled in the art, the audio device within the computer will typically comprise an accessory card, such as a Sound Blaster® compatible sound card 14 (See FIG. 2). Alternatively, a voice modem or other telephony device 16 (See FIG. 3) or any other combination of hardware and software, which can receive an analog audio signal and convert it to a digital form could be used. Those skilled in the art will recognize that the relevant issue in the selection of the audio device is the capability for receiving audio signals and interfacing them to the computer 12.

The present invention will be described in accordance with the preferred embodiment in which a Sound Blaster® compatible sound card 14, as shown in FIG. 2, is used. Those skilled in the art will recognize that a voice modem or other telephony device 16, as shown in FIG. 3, could be used as well.

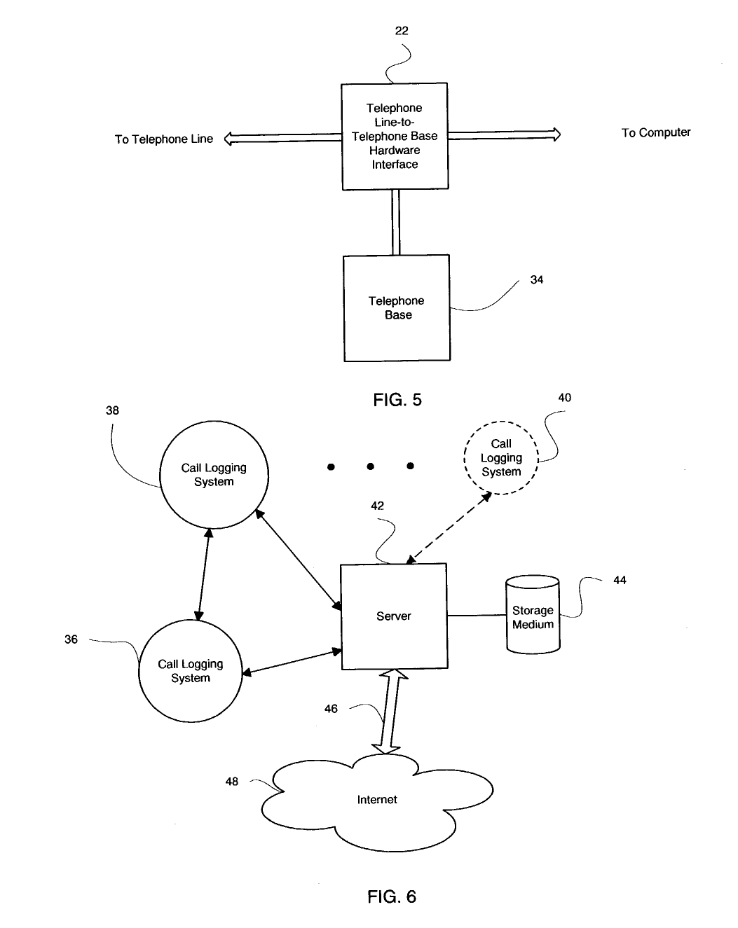

With continued reference to FIGS. 1 and 2, a telephone base 34 having a handset 18 is connected to telephone base-to-handset hardware interface 20. In accordance with the present invention, the telephone base-to-handset hardware interface 20 in the preferred embodiment of the present invention is connected between the telephone base 34 and its handset 18 (See FIG. 4). Alternatively, a telephone line-to-telephone base hardware interface 22 may be selected which is connected between the telephone line and the telephone base 34 (See FIG. 5). Those skilled in the art will recognize that if a voice modem or other telephony device 16 is used, the voice modem or telephony device 16 may take the place of the telephone line-to-telephone base hardware interface 22.

Although the telephone line-to-telephone base hardware interface 22 of FIG. 5 must be FCC Part 68 compliant, this type of interface may be used with speakerphones or cordless telephones. In addition, if a telephone line supports multiple telephones, such as a typical residential telephone line, all telephones may be connected using a telephone line-to-telephone base hardware interface 22. On the other hand, a typical analog telephone line-to-telephone base hardware interface 22 cannot be used to interface a digital telephone line, such as an ISDN line or a broadband line, to a computer.

An advantage of the telephone base-to-handset hardware interface 20, as illustrated in FIGS. 1 and 4, is that it does not have to be FCC Part 68 compliant since it does not connect directly to the telephone line. However, the telephone base-to-handset hardware interface 20 does not permit the use of speakerphones or cordless telephones and if multiple telephones are on a single telephone line, only the telephone or telephones which have a telephone base-to-handset hardware interface 20 may log calls. On the other hand, the telephone base-to-handset hardware interface 20 may be used with a digital PBX, an ISDN line, or a broadband line. Since businesses which regularly log telephone calls, such as customer service operations, will typically have digital telephone lines and computers for each user, the telephone base-to-handset hardware interface 20 is considered to be the preferred embodiment of the hardware interface.

Still referring to FIG. 1, the computer 12 typically also includes a keyboard 24, a pointing device 26 (i.e., a mouse), storage media 28 (i.e., floppy disk drive, hard drive, re-writeable Compact Disc (CD-RW) drive, Digital VideoDisc (DVD) drive, Iomega® Zip® disk drive, removable hard drive, memory card, etc.), a monitor 30, and preferably a network interface card (or built in network interface) which allows the computer 12 to be connected by wire 32, radio frequency (RF)(not shown), or other means (not shown) to a local area network (LAN) or wide area network (WAN).

Turning next to FIG. 6, call logging systems 36, 38, and 40 may be connected to each other and to a server 42 via a LAN or WAN. In accordance with the present invention, the server 42 may include a storage medium 44, such as a hard drive, to retain a database including information about the calls logged on the various call logging systems 36, 38, and 40. In addition, the network may include a connection 46 to the Internet 48. The connection 46 allows any of the systems 36, 38, and 40 or the server 42 to access the Internet.

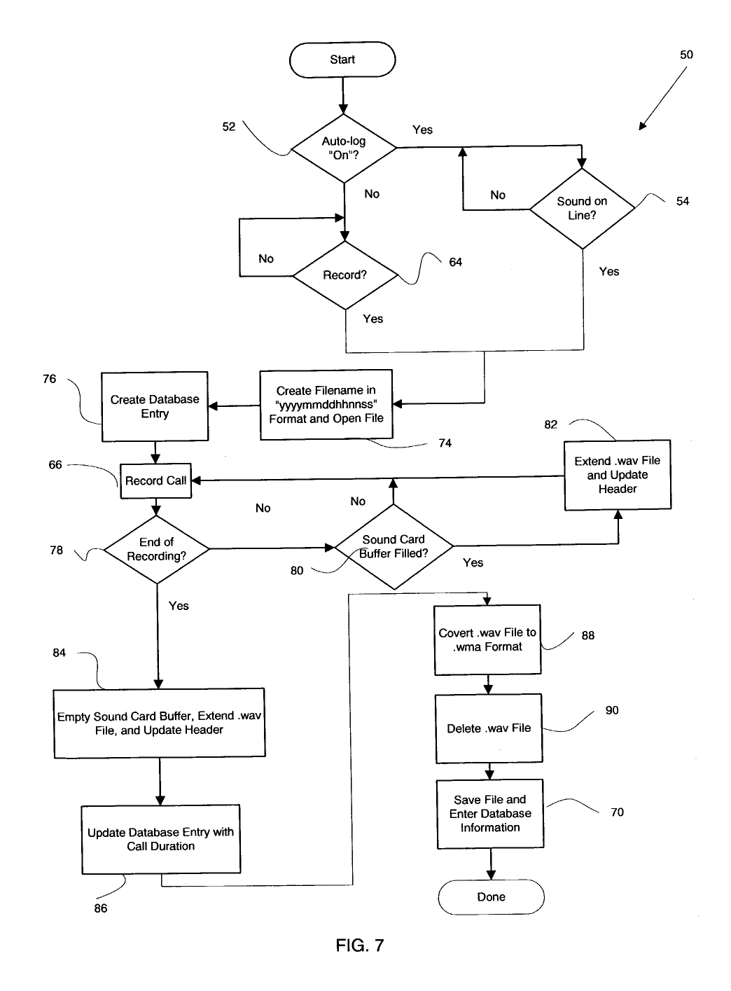

With reference now to FIG. 7, a flowchart is shown illustrating the software operation of the present invention. The present invention includes software, which operates on the computer 12 (See FIG. 1) to perform a variety of functions, as will be understood with reference to flowchart 50. In particular, the software operation includes an Auto-Log function, which enables the software to automatically log telephone calls. As shown in flowchart 50, the Auto-Log function operates by “listening” to the telephone line and measuring the input level at the sound card to determine whether it exceeds a preset threshold value (step 54). If yes, the recording is started. Alternatively, if the Auto-Log function is off, a recording is started at the user's request (e.g., when the user clicks on a “Record” button on the screen of the monitor 30 using the pointing device 26 or when the user enters a command using the keyboard 24)(step 64). It should be noted that even if the Auto-Log function is on, a recording may be started manually.

With continued reference to FIG. 7, when recording begins, a filename is created and a file is opened (step 74) and a new database entry is created for the call (step 76). Preferably, the filename is constructed by the software in the form “yyyymmddhhnnss” with a “.wav” extension where “yyyy” corresponds to a four-digit year, “mm” corresponds to a two-digit month, “dd” corresponds to a two-digit day of the month, and “hhnnss” corresponds to a 24-hour time in hours, minutes, and seconds, with the date and time corresponding to the date and time when the filename is created. Of course, other forms of filenames may be used. The .wav extension corresponds to the standard extension used for wave (audio) files, which are playable with any Microsoft® Windows® compatible media player, such as Microsoft® Windows® Media Player. Thus, in accordance with the preferred embodiment of the present invention, a recording that commences on Nov. 13, 2001 at 25 seconds after 3:37 in the afternoon will be assigned the filename “20011113153725.wav”. As will be known to those skilled in the art, sound cards, such as Sound Blaster® compatible cards, include a buffer (i.e., a reserved segment of memory utilized to hold data while it is being processed), which stores the sampled input in digital form. The system then begins recording (step 66) and monitors the buffer to determine when it is full (step 80). When the buffer is full, the sound card raises an “event”, which initiates a routine in the software to cause the software to update the .wav file by updating its header and extending the file length (step 82). Extending the file length includes transferring the digital data from the buffer to the .wav file.

The end of a recording (step 78) is indicated by either a predetermined period of time, e.g., three seconds, during which the intensity at the input of the sound card is less than the preset threshold (when Auto-Log is on) or when the user requests that the recording stop (e.g., by clicking on a “Stop” button with the pointing device 26 (when Auto-Log is off). In other words, if Auto-Log is on, the call is automatically recorded when the intensity of the signal on the telephone line exceeds the preset threshold (step 54), and the recording ends when the predetermined silence period has been reached. Alternatively, if Auto-Log is off, recording is controlled by the user by entering a “Record” command (step 64) with, for example, the pointing device 26 or the keyboard 24. Here, the call will be recorded (step 66) until a “Stop Recording” command is entered by the user.

Upon detection of the signal to end the recording (step 78), the software flushes the buffer of the sound card (i.e., the software transfers the digital data from memory to disk), again updates the .wav file header, and extends the length of the .wav file to include the data from the buffer (step 84). In addition, the database record associated with the log file is updated with the call duration (step 86). Whereas updating the database may be done each time the length of the .wav file is increased (step 82), this is not preferred because it would result in numerous, unnecessary database connections.

According to the preferred embodiment of the present invention, each recording creates a new .wav file and database record. However, .wav files occupy about 22,050 bytes per second of recording or about 1.3 Megabytes per minute of recording, and thus can occupy a very large amount of space. Those skilled in the art would recognize that this is about one-quarter the size of a compact disc (CD) quality music .wav file, as only one channel is needed. Also, the restricted frequency range of voice (as opposed to music) means that a sampling rate of one-quarter that required by music may be used. Therefore, the recording is made utilizing 16-bit (2 bytes) sampling, which provides sufficient data to allow the compression algorithm to create a quality recording. Nevertheless, a telephone call saved as a .wav file will still be quite large. Accordingly, the .wav file is preferably converted into a .wma file (i.e., a file that is compatible with Microsoft® Windows® Media Player)(step 88). As will be understood by those skilled in the art, the conversion from a .wav format to a .wma format may be accomplished by either a custom conversion program or a utility program such as the Microsoft® Windows® Media 8 Encoding Utility, “wm8eutil.exe”, which is a Microsoft® command-line tool for converting uncompressed audio and video files to a Microsoft® Windows® Media format. This utility is generally available from Microsoft®'s web site. After converting the .wav file to a .wma file (step 88), the file size will be reduced by a factor of about 16.9:1. Once this is accomplished, the .wav file is no longer needed and is deleted (step 90). The database is updated with a reference to the location of the .wma file, however, the actual .wma file is stored in the storage medium 44 and has a file length of approximately 76.4 Kbytes per minute.

After a recording has ended, the user may enter additional information about the call, whereupon the information and the reference to the location of the .wma file are saved in the database (step 70). Whereas the actual call log file may be retained on the hard drive of the users' computers irrespective of the number of users, an important feature of the present invention is that multiple users utilizing different computers may use a single database to store information about their logged calls. In a multiple user system, the database will preferably be on the server's storage medium 44 (See FIG. 6). Thus, when the system in accordance with the present invention is used with multiple users, even if each user retains his respective logged call files, the single, centralized database created by the system allows any user to access any call in which that user, or any other user, participated, because the single, centralized database retains information about all calls, including the location (e.g., machine, drive, path, filename) of each log file.

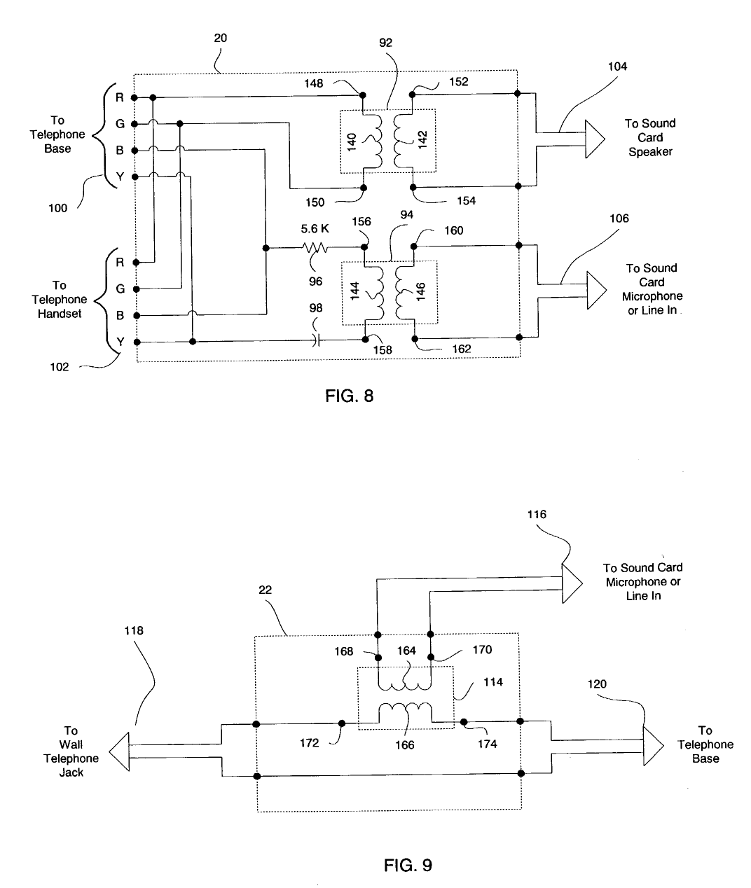

With reference now to FIG. 8, a circuit diagram of the telephone base-to-handset hardware interface 20 of FIG. 4 is shown. The telephone base-to-handset hardware interface 20 includes a pair of isolation transformers 92 and 94, a resistor 96, and a capacitor 98. The first isolation transformer 92 transfers the audio frequency signals from the sound card speaker port 108 (See FIG. 2) to the telephone base 34 and telephone handset 18 (See FIG. 1) and the second isolation transformer 94 transfers the audio frequency signals from the telephone base 34 or telephone handset 18 (See FIG. 1) to the sound card microphone port 110 or the sound card line-in port 112 (See FIG. 2). The first isolation transformer 92 comprises a first winding 140 with two ends 148 and 150 and a second winding 142 with two ends 152 and 154. Both ends 148 and 150 of the first winding 140 are coupled to a connector 100 which interfaces the telephone base-to-handset hardware interface 20 to the telephone base 34 (See FIG. 1). Both ends 152 and 154 of the second winding 142 are coupled to a connector 104, which interfaces the telephone base-to-handset hardware interface 20 to the sound card speaker port 108 (See FIG. 2). The second isolation transformer 94 comprises a first winding 144 with two ends 156 and 158 and a second winding 146 with two ends 160 and 162. One end 156 of the first winding 144 of the second isolation transformer 94 is coupled via the resistor 96 (which preferably has a value of 5.6 Kohms) to the connector 102, which interfaces the telephone base-to-handset hardware interface 20 to the handset 18 (See FIG. 1) and the telephone base 34 (See FIG. 1). The other end 158 of the first winding 144 of the second isolation transformer 94 is also coupled to connector 102 via the capacitor 98 (which preferably has a value of about 10 microfarads) Both ends 160 and 162 of the second winding 146 are coupled to a connector 106, which interfaces the telephone base-to-handset hardware interface 20 to the sound card microphone port 110 or the sound card line-in port 112 (See FIG. 2).

Looking next at FIG. 9, shown is a circuit diagram of an alternative embodiment of the telephone line-to-telephone base hardware interface 22 of FIG. 5. The telephone line-to-telephone base hardware interface 22 is preferably comprised of an isolation transformer 114, which transfers audio frequency signals from the wall telephone jack connector 118 to the sound card microphone port 110 or sound card line-in port 112 (See FIG. 2). The isolation transformer 114 comprises a first winding 164 with two ends 168 and 170 and a second winding 166 with two ends 172 and 174. Both ends 168 and 170 of the first winding 164 are coupled to the connector 116, which interfaces the telephone line-to-telephone base hardware interface 22 to the sound card microphone port 110 or the sound card line-in port 112 connector (See FIG. 2). One end 172 of the second winding 166 is coupled to a wall telephone jack connector (RJ-11) 118, which interfaces the telephone line-to-telephone base hardware interface 22 to a wall telephone jack. The other end 174 of the second winding 166 of the isolation transformer 114 is coupled to a connector (RJ-11) 120, which interfaces the telephone line-to-telephone base hardware interface 22 to the telephone base 34 (See FIG. 1). When the telephone line-to-telephone base 22 is configured as illustrated in FIG. 9, the telephone handset 18 may not be used to listen to recordings, as there is no electrical path from the computer 12 back to the telephone handset 18 (See FIG. 1).

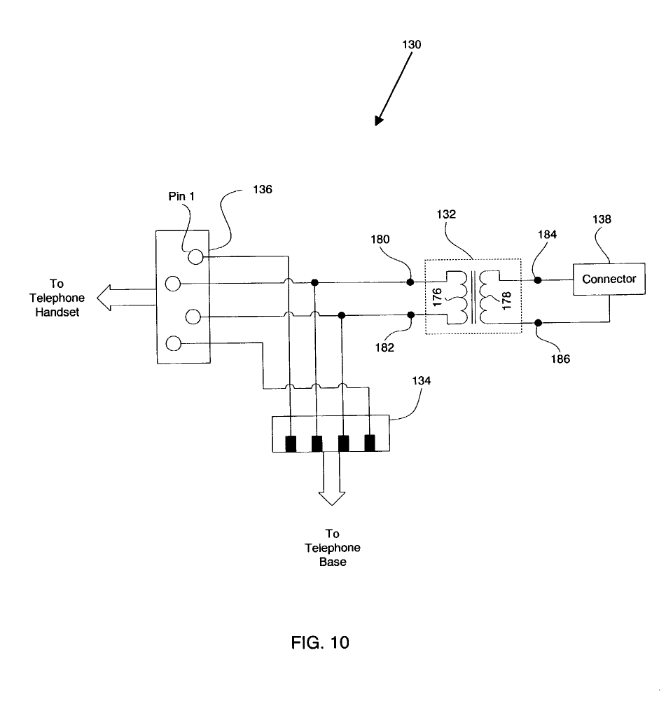

Next, shown in FIG. 10 is a circuit diagram of the telephone base-to-handset hardware interface 130 that may be used as an alternative to the telephone base-to-handset hardware interface 20 illustrated in FIG. 8. As depicted in FIG. 10, the telephone base-to-handset hardware interface 130 includes an isolation transformer 132, such as a 600-ohm to 600-ohm audio frequency transformer, which transfers the audio frequency signals from the telephone base 34 (See FIG. 1) to the connector 138, which may connect the telephone base-to-handset hardware interface 130 to a sound card. The isolation transformer 132 comprises a first winding 176 with two ends 180 and 182 and a second winding 178 with two ends 184 and 186. Both ends 180 and 182 of the first winding 176 are coupled to a first connector 134, such as a male RJ9 connector, which interfaces the telephone base-to-handset hardware interface 130 to the telephone base 34 (See FIG. 1), and are also coupled to a second connector 136, such as a female RJ9 connector, which interfaces the telephone base-to-handset hardware interface 130 to the handset 18 of the telephone (See FIG. 1). Both ends 184 and 186 of the second winding 178 are coupled to a connector 138, such as a male 3.5 mm stereo microphone connector, which interfaces the telephone base-to-handset hardware interface 130 to the sound card microphone port 110 or the sound card line-in port 112 (See FIG. 2). When the telephone base-to-handset hardware interface 130 is configured as illustrated in FIG. 10, the telephone handset 18 may not be used to listen to recordings, as there is no electrical path from the computer 12 back to the telephone handset 18 (See FIG. 1).

If a voice modem or other telephony device 16 (See FIG. 3) is used instead of a telephone base-to-handset hardware interface 20 or telephone line-to-telephone base hardware interface 22, then the voice modem or other telephony device 16 will have a first jack 122 to connect an RJ-11 plug from the wall, and a second jack 124 to connect an RJ-11 plug from the telephone base 34. Use of a voice capable modem allows the present invention to use caller identification information and to automatically include a caller's telephone number in the database. Whereas a voice modem will not allow the present invention to be utilized with a digital telephone line, the voice modem does allow the present invention to be used with speakerphones and cordless telephones.

With reference now back to FIG. 2, there may be times when it is useful to utilize a computer as a sound recording device to record local voice messages or conversations, rather than to log telephone messages. At such times, a microphone 111 may be connected to the sound card microphone port 110 , such that the system of the present invention may be used to accomplish the recording.

In accordance with the preferred embodiment of the system of the present invention, a user is allowed to log telephone calls, and the single, centralized database provides a means whereby the logged telephone calls may be readily retrieved for review by any user.

Another function of the system allows a user to send a copy of the .wma call log file to others via e-mail by using the Internet 48 (See FIG. 6). This allows logged calls to be, for example, collected by a customer service operation in one location and then passed on to management operations in a second location, or service personnel in yet another location. By way of example, a customer service function of a computer company could receive calls from customers who need service. The customer service personnel may log the calls while directing the customer to ship a defective unit in for repair. The database may be notated to include the return merchandise authorization “RMA” number that is assigned to the defective unit. Later, when the merchandise is returned, a technician will be able to match the RMA number to the customer's call and listen to the call to confirm that all complained of problems have been resolved.

In accordance with the preferred embodiment of the present invention, the database is comprised of a Microsoft® Access database, although other, more powerful databases may be used where the volume of calls is such that a more powerful database is required. An advantage of using a database, such as Microsoft® Access, is that the database facilitates the generation of reports about logged calls, users, and other information retained in the database tables.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

1. A method for logging audio recordings, said method comprising the steps of:
receiving an audio signal,
creating a digital file,
creating an entry in a database for storing the location of said digital file,
converting said audio signal to digital data to be stored in said digital file,
compressing said digital file,
storing said digital file in a storage medium, and
storing said location of said digital file in said database entry.

2. A method according to claim 1, said method further comprising the step of:
playing at least a portion of said digital file.

3. A method according to claim 1, said method further comprising the step of:
automatically generating an electronic mail message containing said digital file.

4. A method according to claim 1, said method further comprising the step of:
sharing said database with multiple users via a network.

5. A method for logging audio recordings according to claim 4, wherein said network comprises a local area network (LAN).

6. A method for logging audio recordings according to claim 4, wherein said network comprises a wide area network (WAN).

7. A method according to claim 1, said method further comprising the step of:
prompting a user to enter data relating to said audio recording.

8. A method according to claim 1, said method further comprising the step of:
prompting a user to enter identification data relating to said audio recording,
wherein said identification data allows said user to locate said audio recording in said database.

9. A method for logging audio recordings according to claim 1, wherein said audio recording comprises a telephone conversation.

10. A method for logging audio recordings according to claim 1, wherein said audio recording comprises a voice message.

11. A method for logging audio recordings according to claim 1, wherein said audio signal is received by a hardware interface.

12. A method for logging audio recordings according to claim 11, wherein said hardware interface transfers audio frequency signals from a telephone base to a sound card microphone port.

13. A method for logging audio recordings according to claim 11, wherein said hardware interface transfers audio frequency signals from a telephone base to a sound card line-in port.

14. A method for logging audio recordings according to claim 11, wherein said hardware interface transfers audio frequency signals from a telephone handset to a sound card microphone port.

15. A method for logging audio recordings according to claim 11, wherein said hardware interface transfers audio frequency signals from a telephone handset to a sound card line-in port.

16. A method for logging audio recordings according to claim 11, wherein said hardware interface transfers audio frequency signals from a sound card speaker to a telephone base.

17. A method for logging audio recordings according to claim 11, wherein said hardware interface transfers audio frequency signals from a sound card speaker to a telephone handset.

18. A method for logging audio recordings according to claim 11, wherein said hardware interface transfers audio frequency signals from a wall telephone jack to a sound card microphone port.

19. A method for logging audio recordings according to claim 11, wherein said hardware interface transfers audio frequency signals from a wall telephone jack to a sound card line-in port.

20. A method for logging audio recordings according to claim 1, wherein said audio signal is generated by a cordless telephone.

21. A method for logging audio recordings according to claim 1, wherein said audio signal is generated by a speakerphone.

22. A method for logging audio recordings according to claim 1, wherein said audio signal is generated by a digital telephone.

23. A method for logging audio recordings according to claim 1, wherein said audio signal is received from an Integrated Services Digital Network (ISDN) line.

24. A method for logging audio recordings according to claim 1, wherein said audio signal is received from a broadband telephone line.

25. A method for logging audio recordings according to claim 1, wherein said audio signal is received from a private branch exchange (PBX) line.

26. A method for logging audio recordings according to claim 1, wherein said audio signal is generated by a microphone.

27. A method for logging audio recordings according to claim 1, wherein said audio signal is received when a user activates a record button.

28. A method for logging audio recordings according to claim 27, wherein said record button is a software icon, and wherein said record button is activated by clicking said software icon with a cursor control device.

29. A method for logging audio recordings according to claim 1, wherein said audio signal is received when a telephone transitions from on-hook to off-hook.

30. A method for logging audio recordings according to claim 1, wherein said digital file is a standard wave audio file.

31. A method for logging audio recordings according to claim 1, wherein said digital file may be played with wave audio file player software.

32. A method for logging audio recordings according to claim 1, wherein said digital file is created when a user activates a stop recording button.

33. A method for logging audio recordings according to claim 32, wherein said stop recording button is a software icon, and wherein said stop recording button is activated by clicking said software icon with a cursor control device.

34. A method for logging audio recordings according to claim 1, wherein said digital file is created when a telephone transitions from off-hook to on-hook.

35. A method for logging audio recordings according to claim 1, wherein said audio signal is received by a sound card.

36. A method for logging audio recordings according to claim 1, wherein said audio signal is received by a voice modem.

37. A method for logging audio recordings according to claim 1, wherein said digital file is compressed utilizing a software compression utility.

38. A method for logging audio recordings according to claim 1, wherein said filename is in the format yyyymmddhhnnss.*, wherein yyyy represents a year, mm represents a month, dd represents a day, hh represents an hour, nn represents a minute, ss represents a second, and * represents a file type.

39. A method for logging audio recordings, said method comprising the steps of:
creating a digital file,
naming said digital file,
creating an entry in a database for storing the location of said digital file,
receiving an audio signal via an audio device,
converting said audio signal to a digital file by transferring digital data contained within a buffer of said audio device to said digital file,
compressing said digital file,
saving said digital file in a storage medium, and
saving said location of said digital file in said database entry.

40. A method according to claim 39, said method further comprising the step of:
playing at least a portion of said digital file.

41. A method according to claim 39, said method further comprising the step of:
automatically generating an electronic mail message containing said digital file.

42. A method according to claim 39, said method further comprising the step of:
sharing said database with multiple users via a network.

43. A method for logging audio recordings according to claim 42, wherein said network comprises a local area network (LAN).

44. A method for logging audio recordings according to claim 42, wherein said network comprises a wide area network (WAN).

45. A method according to claim 39, said method further comprising the step of:
prompting a user to enter data relating to said audio recording.

46. A method according to claim 39, said method further comprising the step of:
prompting a user to enter identification data relating to said audio recording,
wherein said identification data allows said user to locate said audio recording in said database.

47. A method for logging audio recordings according to claim 39, wherein said audio recording comprises a telephone conversation.

48. A method for logging audio recordings according to claim 39, wherein said audio recording comprises a voice message.

49. A method for logging audio recordings according to claim 39, wherein said audio signal is received by a hardware interface.

50. A method for logging audio recordings according to claim 49, wherein said hardware interface transfers audio frequency signals from a telephone base to a sound card microphone port.

51. A method for logging audio recordings according to claim 49, wherein said hardware interface transfers audio frequency signals from a telephone base to a sound card line-in port.

52. A method for logging audio recordings according to claim 49, wherein said hardware interface transfers audio frequency signals from a telephone handset to a sound card microphone port.

53. A method for logging audio recordings according to claim 49, wherein said hardware interface transfers audio frequency signals from a telephone handset to a sound card line-in port.

54. A method for logging audio recordings according to claim 49, wherein said hardware interface transfers audio frequency signals from a sound card speaker to a telephone base.

55. A method for logging audio recordings according to claim 49, wherein said hardware interface transfers audio frequency signals from a sound card speaker to a telephone handset.

56. A method for logging audio recordings according to claim 49, wherein said hardware interface transfers audio frequency signals from a wall telephone jack to a sound card microphone port.

57. A method for logging audio recordings according to claim 49, wherein said hardware interface transfers audio frequency signals from a wall telephone jack to a sound card line-in port.

58. A method for logging audio recordings according to claim 39, wherein said audio signal is generated by a cordless telephone.

59. A method for logging audio recordings according to claim 39, wherein said audio signal is generated by a speakerphone.

60. A method for logging audio recordings according to claim 39, wherein said audio signal is generated by a digital telephone.

61. A method for logging audio recordings according to claim 39, wherein said audio signal is received from an Integrated Services Digital Network (ISDN) line.

62. A method for logging audio recordings according to claim 39, wherein said audio signal is received from a broadband telephone line.

63. A method for logging audio recordings according to claim 39, wherein said audio signal is received from a private branch exchange (PBX) line.

64. A method for logging audio recordings according to claim 39, wherein said audio signal is generated by a microphone.

65. A method for logging audio recordings according to claim 39, wherein said audio signal is received when a user activates a record button.

66. A method for logging audio recordings according to claim 65, wherein said record button is a software icon, and wherein said record button is activated by clicking said software icon with a cursor control device.

67. A method for logging audio recordings according to claim 39, wherein said audio signal is received when a telephone transitions from on-hook to off-hook.

68. A method for logging audio recordings according to claim 39, wherein said digital file is a standard wave audio file.

69. A method for logging audio recordings according to claim 39, wherein said digital file may be played with wave audio file player software.

70. A method for logging audio recordings according to claim 39, wherein said digital file is created when a user activates a stop recording button.

71. A method for logging audio recordings according to claim 70, wherein said stop recording button is a software icon, and wherein said stop recording button is activated by clicking said software icon with a cursor control device.

72. A method for logging audio recordings according to claim 39, wherein said digital file is created when a telephone transitions from off-hook to on-hook.

73. A method for logging audio recordings according to claim 39, wherein said audio signal is received by a sound card.

74. A method for logging audio recordings according to claim 39, wherein said audio signal is received by a voice modem.

75. A method for logging audio recordings according to claim 39, wherein said digital file is compressed utilizing a software compression utility.

76. A method for logging audio recordings according to claim 39, wherein said filename is in the format yyyymmddhhnnss.*, wherein yyyy represents the year, mm represents the month, dd represents the day, hh represents the hour, nn represents the minute, ss represents the second, and * represents the file type.

77. A system for logging audio recordings, wherein said system comprises:
an audio signal receiving device having at least one input and at least one output;
an audio signal to digital data conversion circuit having an input thereof coupled to said output of said audio signal receiving device,
a microprocessor device having an input thereof coupled to an output of said audio signal to digital data conversion circuit,
a logging algorithm executed by said microprocessor device for creating a digital file, creating a filename, and transferring said digital data to said digital file,
a compression algorithm executed by said microprocessor device, and
a database,
wherein said logging algorithm creates an entry in said database for storing the location of said digital file and stores said digital file in a storage medium, and
wherein said compression algorithm decreases the size of said digital file.

78. A system according to claim 77, said system further comprising a playback algorithm executed by said microprocessor device, wherein said playback algorithm retrieves and plays at least a portion of said digital file.

79. A system according to claim 77, said system further comprising a playback algorithm executed by said microprocessor device, wherein said playback algorithm allows the user to access said digital file.

80. A system according to claim 77, said system further comprising a playback algorithm executed by said microprocessor device, wherein said playback algorithm generates an electronic mail message containing said digital file.

81. A system according to claim 77, said system further comprising a playback algorithm executed by said microprocessor device, wherein said playback algorithm allows the user to search said database for said digital file.

82. A system according to claim 77, said system further comprising a network connected to said database for sharing said database with multiple users.

83. A system according to claim 82, wherein said network comprises a local area network (LAN).

84. A system according to claim 82, wherein said network comprises a wide area network (WAN).

85. A system according to claim 77, wherein said logging algorithm prompts a system user to enter data relating to said audio recording.

86. A system according to claim 77, wherein said logging algorithm prompts a system user to enter identification data relating to said audio recording, said identification data allowing said user to locate said audio recording in said database.

87. A system according to claim 77, wherein said audio recording comprises a telephone conversation.

88. A system according to claim 77, wherein said audio recording comprises a voice message.

89. A system according to claim 77, wherein said audio signal is received by a hardware interface.

90. A method for logging audio recordings according to claim 89, wherein said hardware interface transfers audio frequency signals from a telephone base to a sound card microphone port.

91. A method for logging audio recordings according to claim 89, wherein said hardware interface transfers audio frequency signals from a telephone base to a sound card line-in port.

92. A method for logging audio recordings according to claim 89, wherein said hardware interface transfers audio frequency signals from a telephone handset to a sound card microphone port.

93. A method for logging audio recordings according to claim 89, wherein said hardware interface transfers audio frequency signals from a telephone handset to a sound card line-in port.

94. A method for logging audio recordings according to claim 89, wherein said hardware interface transfers audio frequency signals from a sound card speaker to a telephone base.

95. A method for logging audio recordings according to claim 89, wherein said hardware interface transfers audio frequency signals from a sound card speaker to a telephone handset.

96. A method for logging audio recordings according to claim 89, wherein said hardware interface transfers audio frequency signals from a wall telephone jack to a sound card microphone port.

97. A method for logging audio recordings according to claim 89, wherein said hardware interface transfers audio frequency signals from a wall telephone jack to a sound card line-in port.

98. A system according to claim 77, wherein said audio signal is generated by a cordless telephone.

99. A system according to claim 77, wherein said audio signal is generated by a speakerphone.

100. A system according to claim 77, wherein said audio signal is generated by a digital telephone.

101. A system according to claim 77, wherein said audio signal is received by an Integrated Services Digital Network (ISDN) line.

102. A system according to claim 77, wherein said audio signal is received by a broadband telephone line.

103. A system according to claim 77, wherein said audio signal is received by a private branch exchange (PBX) line.

104. A system according to claim 77, wherein said audio signal is generated by a microphone.

105. A system according to claim 77, wherein said audio signal receiving device begins receiving said audio signal when a user activates a record button coupled to said microprocessor device.

106. A system according to claim 105, wherein said record button is a software icon, wherein said record button is activated by clicking said software icon with a cursor control device.

107. A system according to claim 77, wherein said audio signal receiving device begins receiving said audio signal when a telephone coupled to said audio signal receiving device transitions from on-hook to off-hook.

108. A system according to claim 77, wherein said digital file is a standard wave audio file.

109. A system according to claim 77, wherein said digital file is played with wave audio file player software.

110. A system according to claim 77, wherein said digital file is created when a user activates a stop recording button coupled to said microprocessor device.

111. A system according to claim 110, wherein said stop recording button is a software icon, wherein said stop recording button is activated by clicking said software icon with a cursor control device.

112. A system according to claim 77, wherein said digital file is created when a telephone coupled to said audio signal receiving device transitions from off-hook to on-hook.

113. A system according to claim 77, wherein said audio signal is converted to digital data by a sound card.

114. A system according to claim 77, wherein said audio signal is received by a voice modem.

115. A system according to claim 77, wherein said logging algorithm assigns filenames to said digital files in the format yyyymmddhhnnss.*, wherein yyyy represents a year, mm represents a month, dd represents a day, hh represents an hour, nn represents a minute, ss represents a second, and * represents a file type.

116. A system for logging audio recordings, said system comprising:
a telephone having at least one output,
a hardware interface circuit having an input thereof coupled to said output of said telephone, said hardware interface circuit receiving an audio signal from said telephone,
a personal computer comprising a sound card, said sound card having an input thereof coupled to an output of said hardware interface circuit, said sound card converting said audio signal to digital data,
a database,
a logging algorithm executed by said personal computer for creating said digital file and transferring said digital data to said digital file, and
a compression algorithm executed by said personal computer for decreasing the size of said digital file,
wherein said logging algorithm stores said digital file in a storage medium and stores the location of said digital file in said database.

117. A system according to claim 116, said system further comprising a playback algorithm executed by said personal computer, wherein said playback algorithm retrieves and plays at least a portion of said digital file.

118. A system according to claim 116, said system further comprising a playback algorithm executed by said personal computer, wherein said playback algorithm allows a user to access said digital file.

119. A system according to claim 116, said system further comprising a playback algorithm executed by said personal computer, wherein said playback algorithm generates an electronic mail message containing said digital file.

120. A system according to claim 116, said system further comprising a playback algorithm executed by said personal computer, wherein said playback algorithm allows the user to search said database for said digital file.

121. A system according to claim 116, wherein said logging algorithm prompts a system user to enter identification data relating to said audio recording, said identification data allowing said user to locate said audio recording.

122. A system according to claim 116, wherein said audio signal is received by a hardware interface.

123. A system according to claim 116, wherein said digital file is a standard wave audio file.

124. A system for logging audio recordings, said system comprising:
a microphone for recording a voice message having at least one output,
a personal computer comprising a sound card, said sound card having an input thereof coupled to said output of said microphone for receiving said voice message, said sound card converting said voice message to digital data,
a database,
a logging algorithm executed by said personal computer for creating a digital file and transferring said digital data to said digital file, and
a compression algorithm executed by said personal computer for decreasing the size of said digital file,
wherein said logging algorithm stores said digital file in a storage medium, stores the location of said digital file in said database, and automatically generates an electronic mail message containing said digital file.

125. A system according to claim 124, said system further comprising a playback algorithm executed by said personal computer, wherein said playback algorithm retrieves and plays at least a portion of said digital file.

126. A system according to claim 124, said system further comprising a playback algorithm executed by said personal computer, wherein said playback algorithm allows the user to access said digital file.

127. A system according to claim 124, said system further comprising a playback algorithm executed by said personal computer, wherein said playback algorithm generates an electronic mail message containing said digital file.

128. A system according to claim 124, said system further comprising a playback algorithm executed by said personal computer, wherein said playback algorithm allows the user to search said database for said digital file.

129. A system according to claim 124, wherein said logging algorithm prompts a system user to enter identification data relating to said audio recording, said identification data allowing said user to locate said audio recording.

130. A system according to claim 124, wherein said audio signal is received by a hardware interface.

131. A system according to claim 124, wherein said digital file is a standard wave audio file.
